(19) United States
(12) Patent Application Publication
(10) Pub. No.: US 2004/0007972 A1
(43) Pub. Date: Jan. 15, 2004

(54) Electro-luminescent device

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,070

(22) Filed: Jul. 10, 2002

(51) Int. Cl. H05B 33/00

(52) U.S. Cl. 313/506

(57) ABSTRACT

An electro-luminescent device including a first facial material and a first electrode assembly arranged on the first facial material. The first electrode assembly includes at least two pattern electrode layers overlapping each other. The two pattern electrode layers are insulated from each other by an insulating layer. A lighting layer is overlaid on the other face of the first electrode assembly. A second electrode assembly is arranged on the other face of the lighting layer. The second electrode assembly includes at least one sub-electrode layer. A second facial material is overlaid on the other face of the second electrode assembly. The pattern electrode layers and the sub-electrode layer are respectively connected with a drive circuit. The pattern electrode layers respectively have multiple conductive patterns. An A.C. voltage is applied to the sub-electrode layer to create an electric field effect in the inductive layer and the lighting layer, whereby the lighting layer is energized to emit light and create a dynamic picture effect.

### BACKGROUND OF THE INVENTION

The present invention is related to an electro-luminescent device, and more particularly to an electro-luminescent device in which a first electrode assembly includes multiple pattern electrode layers having multiple conductive patterns overlapping each other. The conductive patterns cooperate with a lighting layer to emit light and create a continuous dynamic picture effect.

FIGS. 6A and 6B show a conventional electro-luminescent device (EL device). An A.C. voltage is applied to the front face electrode 91 and back face electrode 92 to create an electric field in the inductive layer 93 and the lighting layer 94. The lighting layer 94 is energized to emit light serving as backlight of an electronic product, display panel, warning sign, indication sign or advertisement sign. In the single lighting layer structure of the existent EL device, according to pattern or character design, by means of blending different colors with the lighting layer, the lighting layer can emit different colors of lights. In cooperation with a drive module, various dynamic bright and dark effects can be achieved. For example, the conventional EL jumping light, EL advertisement sign, etc. can achieve such effects. However, although such EL device can achieve bright and dark effect, it can only provide dynamic change of separate patterns or characters. The conventional EL device can hardly provide overlapping dynamic picture effects (as shown in FIG. 6B).

FIG. 7 shows an EL device, which is able to achieve dynamic effect. Multiple complementary and separate conductive patterns 611˜618 are arranged on one single back face electrode 61 without overlapping each other. Under control of the drive module, the conductive patterns 611˜618 create dynamic picture effect. However, the lighting effect created by such EL device on the lighting layer 62 is unable to present a complete picture. Breaks exist between the conductive patterns 611˜618 (as between conductive patterns 611, 612 and 613). Accordingly, the display effect of the picture is reduced and the visual effect is poor.

### SUMMARY OF THE INVENTION

It is therefore a primary object of the present invention to provide an electro-luminescent device in which a first electrode assembly includes multiple pattern electrode layers which have multiple conductive patterns overlapping each other. When driving a lighting layer to emit light, the conductive patterns and the sub-electrode layer of the second electrode assembly create an electric field effect in the inductive layer and the lighting layer, whereby the lighting layer is energized to emit light and create a continuous dynamic picture effect.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a sectional assembled view of the first embodiment of the present invention;

FIG. 3 shows that the first and second back face electrode layers of the second electrode assembly of the first embodiment overlap each other, in which the first, third, fifth, seventh and ninth conductive patterns of the first back face electrode layer partially overlap the second, fourth, sixth, eighth and tenth conductive patterns of the second back face electrode layer;

FIG. 4A shows that the first conductive pattern of the first embodiment is driven to emit light;

FIG. 4B shows that the second conductive pattern of the first embodiment is driven to emit light;

FIG. 4C shows that the third conductive pattern of the first embodiment is driven to emit light;

FIG. 4D shows that the fourth conductive pattern of the first embodiment is driven to emit light;

FIG. 4E shows that the fifth conductive pattern of the first embodiment is driven to emit light;

FIG. 4F shows that the sixth conductive pattern of the first embodiment is driven to emit light;

FIG. 4G shows that the seventh conductive pattern of the first embodiment is driven to emit light;

FIG. 4H shows that the eighth conductive pattern of the first embodiment is driven to emit light;

FIG. 4I shows that the ninth conductive pattern of the first embodiment is driven to emit light;

FIG. 4J shows that the tenth conductive pattern of the first embodiment is driven to emit light;

FIG. 5 is a sectional assembled view of a second embodiment of the present invention;

FIG. 6A is a sectional assembled view of a conventional electro-luminescent device;

FIG. 6B shows a driven picture of the conventional electro-luminescent device; and

FIG. 7 shows a driven picture of another type of conventional electro-luminescent device, in which there are breaks between the conductive patterns.

### DETAILED DESCRIPTION OF THE PREFERRED EMBODIMENTS

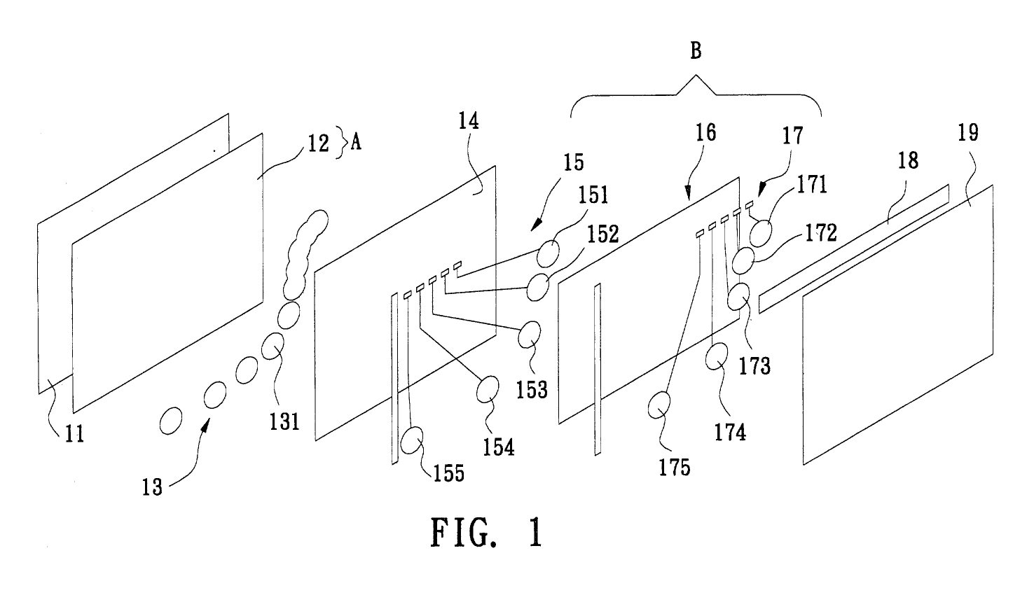

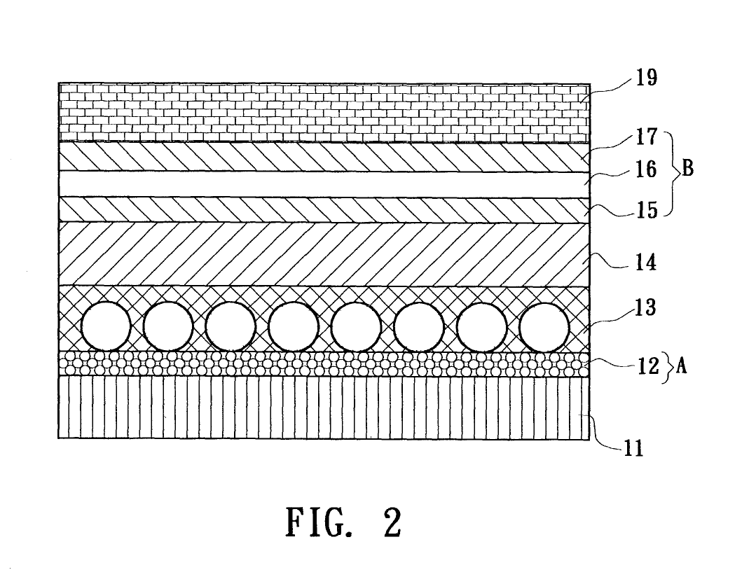

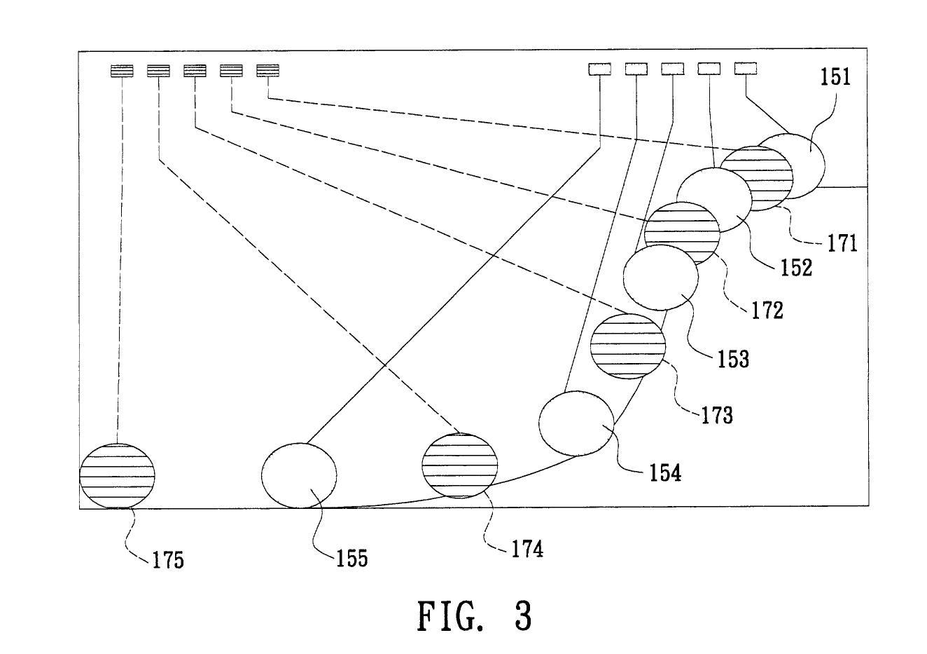

Please refer to FIGS. 1 to 4J. According to a first embodiment, the present invention includes a transparent substrate material 11 as a first facial material. A first electrode assembly A is arranged on the transparent substrate material 11. The first electrode assembly A includes a front face electrode layer 12 which is a sub-electrode layer. A lighting layer 13 is overlaid on the front face electrode layer 12. In this embodiment, the lighting layer 13 includes multiple lighting patterns 131 of an elliptic ball body acceleratively falling down in a predetermined track. Some of the lighting patterns 131 are connected with each other, while the other of the lighting patterns 131 are not connected. An inductive layer 14 is overlaid on the lighting layer 13. A second electrode assembly B is arranged on the inductive layer 14. The second electrode assembly B includes a first back face electrode layer 15 and a second back face electrode layer 17 which are pattern electrode layers overlapping each other. An insulating layer 16 is overlaid on the first back face electrode layer 15 for insulating the first back face electrode layer 15 from the second back face electrode layer 17. A differential conductive layer 18 is disposed on the second back face electrode layer 17. A packaging layer 19 is overlaid on the differential conductive layer 18 as a second facial material. The front face electrode layer 12, the first back face electrode layer 15 and the second back face electrode layer 17 are connected to a drive circuit (not shown). On the first back face electrode layer 15 are disposed a first, a third, a fifth, a seventh and a ninth conductive patterns 151, 152, 153, 154, 155 arranged in a predetermined path. (In this embodiment, the first, third, fifth, seventh and ninth conductive patterns 151, 152, 153, 154, 155 are respectively opposite to a part of predetermined track of the lighting pattern 131 of the lighting layer 13. In addition, the first, third, fifth, seventh and ninth conductive patterns 151, 152, 153, 154, 155 are not overlapped with each other.) On the second back face electrode layer 17 are disposed a second, a fourth, a sixth, an eighth and a tenth conductive patterns 171, 172, 173, 174, 175 arranged in the same path as the first, third, fifth, seventh and ninth conductive patterns 151, 152, 153, 154, 155. The first, third, fifth, seventh and ninth conductive patterns 151, 152, 153, 154, 155 of the first back face electrode layer 15 partially overlap the second, fourth, sixth, eighth and tenth conductive patterns 171, 172, 173, 174, 175 of the second back face electrode layer 17. Moreover, the first, third, fifth, seventh and ninth conductive patterns 151, 152, 153, 154, 155 of the first back face electrode layer 15 and the second, fourth, sixth, eighth and tenth conductive patterns 171, 172, 173, 174, 175 of the second back face electrode layer 17 are respectively connected to the drive circuit.

It should be noted that the drive circuit is respectively connected to the first, third, fifth, seventh and ninth conductive patterns 151, 152, 153, 154, 155 of the first back face electrode layer 15 and the second, fourth, sixth, eighth and tenth conductive patterns 171, 172, 173, 174, 175 of the second back face electrode layer 17. The drive circuit can solely drive one single conductive pattern of the first back face electrode layer 15 or the second back face electrode layer 17. Accordingly, the lighting pattern 131 of the lighting layer 13 can emit light beam with predetermined profile corresponding to the conductive pattern. In addition, the first, third, fifth, seventh and ninth conductive patterns 151, 152, 153, 154, 155 of the first back face electrode layer 15 and the second, fourth, sixth, eighth and tenth conductive patterns 171, 172, 173, 174, 175 of the second back face electrode layer 17 partially overlap each other. When the drive circuit repeatedly sequentially drives the first, second, third, fourth, fifth, sixth, seventh, eighth, ninth and tenth conductive patterns 151, 171, 152, 172, 153, 173, 154, 174, 155, 175, an electric field effect is induced and generated in the lighting layer 13 and inductive layer 14 in positions corresponding to the respective conductive patterns. The light layer 13 is energized to emit light in these positions to create dynamic picture effect.

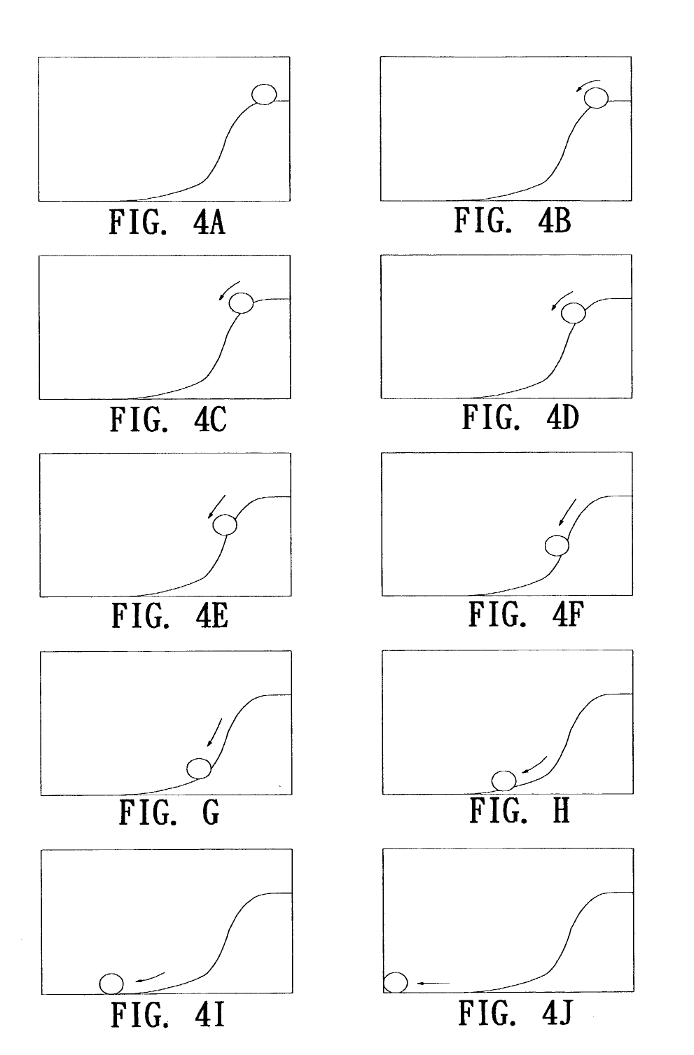

Referring to FIGS. 4A to 4J, when the drive circuit first drives the first conductive pattern 151 of the first back face electrode layer 15 of the second electrode assembly B and the front face electrode layer 12 of the first electrode assembly A to electrically connect the first conductive pattern 151 with the front face electrode layer 12, the lighting layer 13 can emit light in a position corresponding to the first conductive pattern 151 and with a profile identical to that of the first conductive pattern 151 (as shown in FIG. 4A). Then, the drive circuit cuts off the current of the first conductive pattern 151 of the first back face electrode layer 15 and quickly electrically connect the second conductive pattern of the second back face electrode layer 17, whereby the lighting layer 13 can emit light in a position corresponding to the second conductive pattern 171 and with a profile identical to that of the second conductive pattern 171 (as shown in FIG. 4B). Accordingly, the first, second, third, fourth, fifth, sixth, seventh, eighth, ninth and tenth conductive patterns 151, 171, 152, 172, 153, 173, 154, 174, 155, 175 are sequentially repeatedly electrically connected, whereby the lighting layer 13 can emit light at different times in different positions. The respective conductive patterns of the first and second back face electrode layers 15, 17 partially overlap each other. Therefore, the lighting layer 13 can emit light in accordance with the predetermined track of the acceleratively falling down elliptic ball body so as to achieve a visually continuous dynamic picture effect.

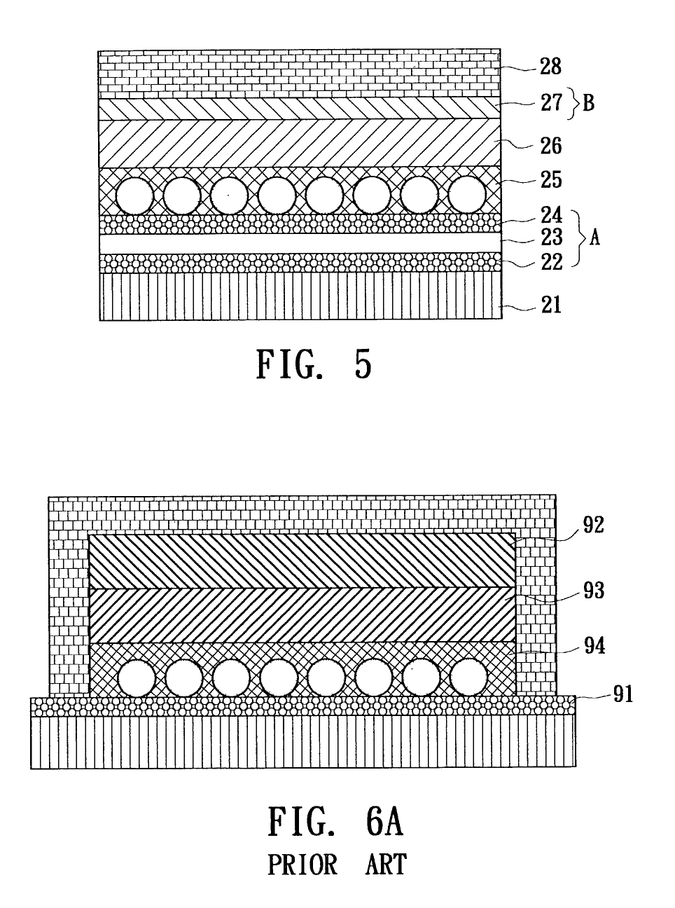

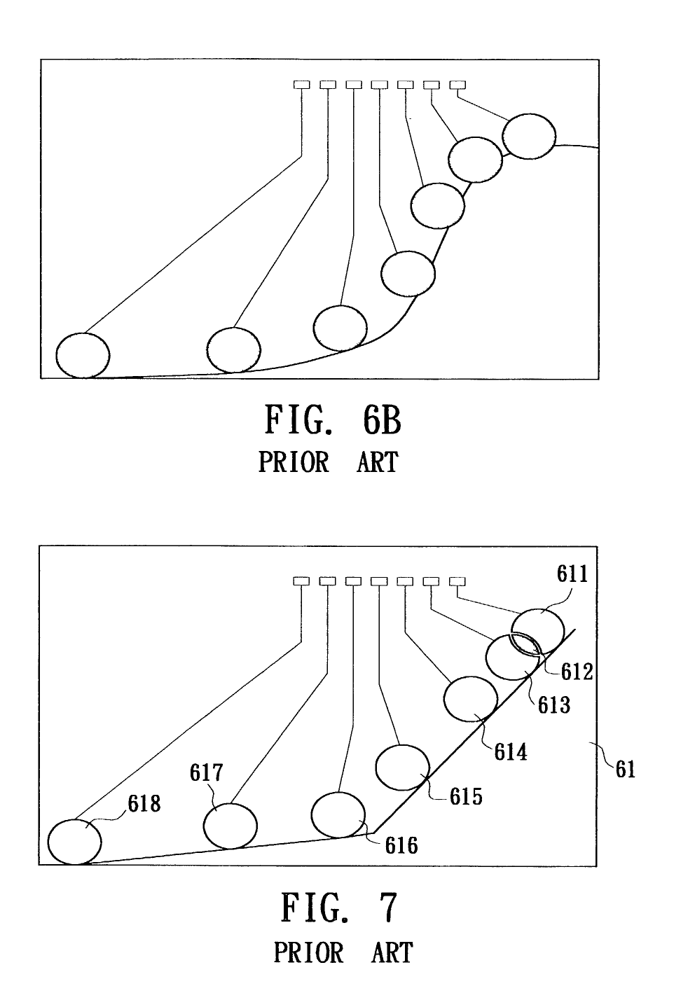

FIG. 5 shows a second embodiment of the present invention, in which a transparent substrate material 21 serves as a second facial material. A second electrode assembly B is arranged on the transparent substrate material 21. The second electrode assembly B includes a first front face electrode layer 22 and a second front face electrode layer 24 which are pattern electrode layers. The first and second front face electrode layers 22, 24 are insulated from each other by an insulating layer 23 there between. A lighting layer 25 is overlaid on the second front face electrode layer 24. An inductive layer 26 is overlaid on the lighting layer 25. A first electrode assembly A is arranged on the inductive layer 26. The first electrode assembly A includes a back face electrode layer 27 which is a sub-electrode layer. A packaging layer 28 is overlaid on the back face electrode layer 27 as a first facial material. As the first and second back face electrode layers in the first embodiment, the first and second front face electrode layers 22, 24 are both pattern electrode layers and have conductive patterns (not shown). The drive circuit (not shown) can drive the conductive patterns of the first and second front face electrode layers 22, 24, making the lighting layer 25 emit light to achieve dynamic picture effect as the first embodiment.

The above embodiments are only used to illustrate the present invention, not intended to limit the scope thereof. Many modifications of the above embodiments can be made without departing from the spirit of the present invention.

What is claimed is:

1. An electro-luminescent device comprising a first facial material, a first electrode assembly being arranged on one face of the first facial material, the first electrode assembly including at least two pattern electrode layers overlapping each other, the two pattern electrode layers being insulated from each other by an insulating layer therebetween, a lighting layer being overlaid on one face of the first electrode assembly distal from the first facial material, a second electrode assembly being arranged on one face of the lighting layer distal from the first electrode assembly, the second electrode assembly including at least one sub-electrode layer, a second facial material being overlaid on one face of the second electrode assembly distal from the lighting layer, the pattern electrode layers and the sub-electrode layer being respectively connected with a drive circuit, the pattern electrode layers respectively having multiple conductive patterns.

2. The electro-luminescent device as claimed in claim 1, wherein the first facial material is a transparent substrate material, while the second facial material is a packaging layer, the pattern electrode layers of the first electrode assembly respectively being two front face electrode layers, the sub-electrode layer of the second electrode assembly being a back face electrode layer, a differential conductive layer being disposed between the back face electrode layer and the second facial material.

3. The electro-luminescent device as claimed in claim 1, wherein the first facial material is packaging layer, while the second facial material is a transparent substrate material, the pattern electrode layers of the first electrode assembly respectively being two back face electrode layers, the sub-electrode layer of the second electrode assembly being a front face electrode layer, a differential conductive layer being disposed between the back face electrode layer and the first facial material.

4. The electro-luminescent device as claimed in claim 1, wherein at least one inductive layer is disposed between the lighting layer and the first electrode assembly.

5. The electro-luminescent device as claimed in claim 1, wherein at least one inductive layer is disposed between the lighting layer and the second electrode assembly.

6. The electro-luminescent device as claimed in claim 1, wherein the lighting layer has multiple lighting patterns.
